(19) United States
(12) Patent Application Publication
(10) Pub. No.: US 2020/0032099 A1
(43) Pub. Date: Jan. 30, 2020

(54) THERMOSETTING COATING COMPOSITION FOR IMPROVED CORROSION PROTECTION OF METAL SUBSTRATES

(71) Applicant: Eastman Chemical Company, Kingsport, TN (US)

(72) Inventors: Geoffrey Richard Webster, JR., Kingsport, TN (US); Joseph Connell Tilly, Raleigh, NC (US)

(73) Assignee: Eastman Chemical Company, Kingsport, TN (US)

(21) Appl. No.: 16/046,256

(22) Filed: Jul. 26, 2018

(51) Int. Cl. C09D 175/06; C08G 18/42; C08G 18/62; C08G 18/71; C08G 18/24; C09D 175/04; C09D 5/08

(52) U.S. Cl. CPC C09D 175/06; C08G 18/42; C08G 18/622; C08G 2150/90; C08G 18/246; C09D 175/04; C09D 5/08; C08G 18/715

(57) ABSTRACT

Disclosed is a composition for improving the corrosion resistance of metals coated with 2K coatings. The composition comprises a polyol resin having a sulfonyl isocyanate grafted onto the resin. The polyol resins are polyester polyols and acrylic polyols. The grafted resins significantly improve metal corrosion resistance on smooth metal substrates when the grafted resins are incorporated into 2K coating systems.

### FIELD OF THE INVENTION

The invention generally relates to the field of organic chemistry. In particular, it relates to the use of a grafted resin in a coating composition to improve corrosion resistance of metal substrates. More particularly it relates to grafting a sulfonyl isocyanate to active sites on a polyester, polyacrylic or other polyol resin and using the grafted resin in a 2K coating composition to provide improved corrosion resistance of metal substrates.

### BACKGROUND OF THE INVENTION

In many coating applications, a primer is used to provide corrosion protection to a metal substrate, and one or more layers of coatings are applied above the primer to provide good weathering and appearance. Many attempts have been made to develop a single layer, direct to metal coating, for use in protective maintenance and original equipment manufacturing (OEM) coatings. In general, these coatings do not perform as well as desired by the market. The present invention addresses this need as well as others, which will become apparent from the following description and the appended claims.

For protective coatings and OEM coatings requiring high levels of corrosion protection for the metal substrate, the current state of the art is multiple coating layers. In general, an anticorrosive primer and a weatherable protective topcoat are typically applied to a metal substrate. This multiple layer system adds both labor and material cost to coatings designed for use in OEM and coatings for infrastructure maintenance.

There have been many attempts for single layer or direct to metal coatings (DTM), but performance is generally a compromise. To have good weathering, they need to be non-aromatic. These types of coatings have been shown to have weak adhesion to many metal substrates, such as cold rolled steel, galvanized steel or substrates with phosphate pretreatments. This is observed by rapid adhesion failure in very short periods in corrosion testing such as ASTM B117.

Polyester polyols based on 2,2,4,4, tetramethyl 1,3 cyclobutane diol (TMCD) show superior DTM corrosion compared to conventional acrylic polyols over rough (SP10 shot blasted) steel. However, on smooth substrates, such as cold rolled steel, galvanized steel, iron phosphated steel, there is little differentiation between the acrylic polyols and TMCD polyester polyols.

A need exists for a resin when used in a paint formulation that significantly improves metal corrosion resistance of single layer protective maintenance and OEM coatings. The present invention addresses this need as well as others, which will become apparent from the following description and the appended claims.

### SUMMARY OF THE INVENTION

The invention is as set forth in the appended claims.

Briefly, the invention provides a resin composition for use in a coating. The resin composition includes a polyol component having not more than 25 percent sulfonyl urethane groups.

In other embodiments of the invention, the polyol component of the resin composition is a polymer. In other embodiments, the polymer can be a polyester polyol or an acrylic polyol.

In other embodiments, the resin composition comprises the residues of a polymer and an aromatic sulfonyl isocyanate. In other embodiments, the aromatic sulfonyl isocyanate is selected from the group consisting of paratoluenesulfonyl isocyanate, benzyl methyl ester sulfonyl isocyanate, and benzyl sulfonyl isocyanate.

In another embodiment the invention provides a composition for use in a coating comprising the residues of:

a) a polyol having an initial OH Fn greater than 2.66; and

b) an aromatic sulfonyl isocyanate

wherein said composition has not more than 25 percent sulfonyl urethane groups and not less than 75 percent remaining hydroxyl groups.

In another embodiment the invention provides a coating composition comprising:

a) at least one polyester resin comprising residues of a polyester polyol and an aromatic sulfonyl isocyanate wherein said resin has not more than 25 percent sulfonyl urethane groups and not less than 75 percent hydroxyl groups;

b) a solvent other than water; and

c) a crosslinker comprising a polymeric isocyanate, wherein said isocyanate is selected from the group consisting of an aliphatic poly isocyanate; an aromatic poly isocyanate, an aliphatic isocyanate; an aromatic isocyanates and mixtures thereof.

In another embodiment the invention provides a coating composition comprising:

a) at least one acrylic resin comprising residues of an acrylic polyol and an aromatic sulfonyl isocyanate wherein said resin has not more than 25 percent sulfonyl urethane groups and not less than 75 percent remaining hydroxyl groups;

b) a solvent other than water; and

c) a crosslinker comprising a polymeric isocyanate, wherein said isocyanate is selected from the group consisting of an aliphatic poly isocyanate; an aromatic poly isocyanate, an aliphatic isocyanate; an aromatic isocyanates and mixtures thereof.

In another embodiment the invention provides a method of improving the corrosion resistance of a metal substrate comprising:

a) forming a polyester resin, said resin comprising the residues of at least two polyol components and at least one acid component wherein at least one of said polyol components contains free hydroxyl functionality;

b) reacting an aromatic sulfonyl isocyanate with said resin to form a grafted polyester resin wherein said grafted polyester resin has not more than 25 percent sulfonyl urethane groups and not less than 75 percent hydroxyl groups;

c) combining said grafted polyester with a coating composition; and

d) coating said metal substrate with said combined grafted polyester and coating composition.

In yet another embodiment the invention provides a method of improving the corrosion resistance of a metal substrate comprising:

a) forming an acrylic polyol resin, said resin comprising the residues of the radical copolymerization of an acrylic monomer with an ester wherein at least one of said acrylic polyol components contains free hydroxyl functionality;

b) reacting an aromatic sulfonyl isocyanate with said acrylic polyol resin to form a grafted acrylic polyol resin wherein said grafted acrylic polyol resin has not more than 25 percent sulfonyl urethane groups and not less than 75 percent hydroxyl groups;

c) combining said grafted acrylic polyol resin with a coating composition; and

d) coating said metal substrate with said combined grafted acrylic polyol resin and coating composition.

In other embodiments the methods further comprise a step e) combining an ungrafted aromatic sulfonyl isocyanate with said grafted resin.

### BRIEF DESCRIPTION OF THE DRAWINGS

The detailed description is described with reference to the accompanying figures.

FIG. 1 is an illustration of a scribed panel.

FIG. 2 is a plot of corrosion width (mm) on shot blasted steel for Tetrashield IC3020 and Nuplex acrylic.

FIG. 3 is plot of corrosion width (mm) on iron phosphated steel for Tetrashield IC3020 and Nuplex acrylic.

FIG. 4 is a plot of corrosion width (mm) on hot dipped galvanized steel for Tetrashield IC3020 and Nuplex acrylic.

FIG. 5 is a plot of corrosion width (mm) on cold rolled steel for Tetrashield IC3020 and Nuplex acrylic.

FIG. 6 is a plot of corrosion width (mm) on Iron Phosphate Treated Cold Rolled Steel (B1000) and Cold Rolled Steel (CRS) at 250 hours.

FIG. 7 is a plot of corrosion width (mm) on Iron Phosphate Treated Cold Rolled Steel (B1000) and Cold Rolled Steel (CRS) at 750 hours.

FIG. 8 is a plot of corrosion width (mm) on Iron Phosphate Treated Cold Rolled Steel (B1000) and Cold Rolled Steel (CRS) for paint formulations having no PTSI, Grafted PTSI and Post Add PTSI at 250 hours.

FIG. 9 is a plot of corrosion width (mm) on Iron Phosphate Treated Cold Rolled Steel (B1000) and Cold Rolled Steel (CRS) for paint formulations having no PTSI, Grafted PTSI and Post Add PTSI at 750 hours.

FIG. 10 is a plot of corrosion width (mm) on Iron Phosphate Treated Cold Rolled Steel (B1000) and Cold Rolled Steel (CRS) for paint formulations having no PTSI, Grafted PTSI and methyl ester sulfonyl isocyanate at 250 hours.

FIG. 11 is a plot of corrosion width (mm) on Iron Phosphate Treated Cold Rolled Steel (B1000) and Cold Rolled Steel (CRS) for paint formulations having no PTSI, Grafted PTSI and methyl ester sulfonyl isocyanate at 750 hours

### DETAILED DESCRIPTION OF THE INVENTION

As used herein the term “polyol” means an organic compound containing multiple hydroxyl groups. For purposes of this application, a “diol” is a polyol having two hydroxyl groups.

The term “polyester polyol” means a polymer resulting from the polycondensation of a diacid or polyacid with a diol or polyol with sufficient excess alcohol to ensure non-gelation.

The term “acrylic polyol” means a polymer resulting from radical copolymerization of acrylic monomers (ternary or quaternary copolymers), such as acrylic or methacrylic acids with esters.

The term “grafting” means formation of a chemical bond between hydroxyl functionality of a polyol and an aromatic sulfonyl isocyanate to form a urethane linkage.

The term “1K coating” means a coating that does not require a hardener, catalyst or activator to cure.

The term “2K coating” means a coating that requires a hardener, catalyst or activator to cure.

While attempts have been made to be precise, the numerical values and ranges described herein should be considered approximations (even when not qualified by the term “about”). These values and ranges may vary from their stated numbers depending upon the desired properties sought to be obtained by the present invention as well as the variations resulting from the standard deviation found in the measuring techniques. Moreover, the ranges described herein are intended and specifically contemplated to include all sub-ranges and values within the stated ranges. For example, a range of 50 to 100 is intended to describe and include all values within the range including sub-ranges such as 60 to 90 and 70 to 80.

Unless indicated to the contrary, the numerical parameters set forth in the following specification and attached claims are approximations that may vary depending upon the desired properties sought to be obtained by the present invention. At the very least, each numerical parameter should be construed considering the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10. Also, a range associated with chemical substituent groups such as, for example, “C₁ to C₅ diols”, is intended to specifically include and disclose C₁, C₂, C₃, C₄ and C₅ diols.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in its respective testing measurements.

As used in the specification and the appended claims, the singular forms “a,” “an” and “the” include their plural referents unless the context clearly dictates otherwise. For example, a reference to a “polyester,” a “dicarboxylic acid”, a “residue” is synonymous with “at least one” or “one or more” polyesters, dicarboxylic acids, or residues and is thus intended to refer to both a single or plurality of polyesters, dicarboxylic acids, or residues. In addition, references to a composition “comprising”, “containing”, “having” or “including” “an” ingredient or “a” polyester is intended to include other ingredients or other polyesters, respectively, in addition to the specifically identified ingredient or residue. Accordingly, the terms “containing”, “having” or “including” are intended to be synonymous and may be used interchangeably with the term “comprising”, meaning that at least the named compound, element, particle, or method step, etc., is present in the composition or article or method, but does not exclude the presence of other compounds, catalysts, materials, particles, method steps, etc., even if the other such compounds, material, particles, method steps, etc., have the same function as what is named, unless expressly excluded in the claims.

Also, it is to be understood that the mention of one or more process steps does not preclude the presence of additional process steps before or after the combined recited steps or intervening process steps between those steps expressly identified. Moreover, the lettering of process steps or ingredients is a convenient means for identifying discrete activities or ingredients and the recited lettering can be arranged in any sequence, unless otherwise indicated.

The term “polyester”, as used herein, is synonymous with the term “resin” and is intended to mean a thermosetting surface coating polymer prepared by the polycondensation of one or more acid components and hydroxyl components. The curable, aliphatic polyester of the present invention is a thermoset polymer and is suitable as a resin for solvent-based coatings and more specifically mono-coat applications. This polyester has a low molecular weight, typically 500 to 10,000 Daltons, and may not be suitable for fabrication films, sheets, and other shaped objects by extrusion, casting, blow molding, and other thermoforming processes commonly used for high molecular weight thermoplastic polymers. The polyester has a reactive functional group, typically a hydroxyl group or carboxyl group, for the purpose of later reacting with a crosslinker in a coating formulation. The functional group is controlled by having either excess diol or acid (from dicarboxylic acid or tricarboxylic acid) in the polyester resin composition. The desired crosslinking pathway will determine whether the polyester resin will be hydroxyl-terminated or carboxylic acid-terminated. This concept is known to those skilled in the art and described, for example, in Organic Coatings Science and Technology, 2nd ed., p. 246-257, by Z. Wicks, F. Jones, and S. Pappas, Wiley, New York, 1999.

Typically, the acid component comprises at least one dicarboxylic acid and may, optionally, include mono- and polybasic carboxylic acids. For example, the curable, aliphatic polyester may be prepared from an acid component comprising an aliphatic or cycloaliphatic dicarboxylic acid such as, for example, adipic acid or 1,2-cyclohexanedicarboxylic acid, or 1,3-cyclohexanedicarboxylic acid, or a mixture of one or more aliphatic and cycloaliphatic acids. The hydroxyl component comprises diols and polyols. The diols may comprise one or more cycloaliphatic diols such as, for example, 2,2,4,4-tetramethyl-1,3-cyclobutanediol (TMCD), either alone or in combination with one or more linear or branched aliphatic diols such as, for example, neopentyl glycol. Catalysts may be used to accelerate the rate of the polycondensation reaction. Additional examples of acid components and hydroxyl components, other than TMCD of the curable, aliphatic polyester include those known in the art including, but not limited to, those discussed below, and in various documents known in the art such as, for example, in Resins for Surface Coatings, Vol. III, p. 63-167, ed. by P. K. T. Oldring and G. Hayward, SITA Technology, London, U K, 1987.

The term “residue”, as used herein in reference to the polymers of the invention, means any organic structure incorporated into a polymer through a polycondensation or ring opening reaction involving the corresponding monomer. It will also be understood by persons having ordinary skill in the art, that the residues associated within the various curable polyesters of the invention can be derived from the parent monomer compound itself or any derivative of the parent compound. For example, the dicarboxylic acid residues referred to in the polymers of the invention may be derived from a dicarboxylic acid or its associated acid halides, esters, salts, anhydrides, or mixtures thereof. Thus, as used herein, the term “dicarboxylic acid” is intended to include dicarboxylic acids and any derivative of a dicarboxylic acid, including its associated acid halides, esters, half-esters, salts, half-salts, anhydrides, and mixtures thereof, useful in a polycondensation process with a diol to make a curable, aliphatic polyester.

Paratoluenesulfonyl isocyanate (PTSI) is an isocyanate material commonly used as an additive to coating systems to remove moisture that has been introduced with solvents, pigments, and fillers in 1K and 2K polyurethane systems. Instead of merely adding PTSI to a coating formulation as a water scavenger, we have discovered that grafting a sulfonyl isocyanate onto a polyol resin, and incorporating the grafted resin into 2K coating systems can significantly improve metal corrosion on smooth metal substrates. The grafted resin of this invention has utility when the resins are polyester polyols and acrylic polyols. The initial polyol OH Fn should be greater than 2.0, preferably >2.5 and after reacting with an aromatic sulfonyl isocyanate the resulting grafted polyol resin preferably maintain OH Fn>2.

Suitable polyester resins for use in this invention are aliphatic polyester compositions comprising the residues:

a) of 2,2,4,4-tetraalkylcyclobutane-1,3-diol (TACD) represented by the structure

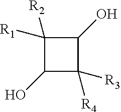

wherein R1, R2, R3, and R4 each independently are C₁ to C₈ alkyls; and

b) a diacid component

In particular, polyesters comprising residues of TACD, and more particularly, 2,2,4,4-tetramethyl-1,3-cyclobutanediol (abbreviated herein as “TMCD”) have utility when grafted with a sulfonyl isocyanate in coating compositions to improve metal corrosion resistance.

The TACD compounds can be represented by the general structure below:

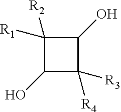

wherein R1, R2, R3, and R4 each independently represent an alkyl radical, for example, a lower alkyl radical having 1 to 8 carbon atoms; or 1 to 6 carbon atoms, or 1 to 5 carbon atoms, or 1 to 4 carbon atoms, or 1 to 3 carbon atoms, or 1 to 2 carbon atoms, or 1 carbon atom. The alkyl radicals may be linear, branched, or a combination of linear and branched alkyl radical. Desirably, the polyhydroxyl compounds are hydrocarbons and do not contain atoms other than hydrogen, carbon and oxygen. Examples of suitable diols include 2,2,4,4-tetramethylcyclobutane-1,3-diol, 2,2,4,4-tetraethylcyclobutane-1,3-diol, 2,2,4,4-tetra-n-propylcyclobutane-1,3-diol, 2,2,4,4-tetra-n-butylcyclobutane-1,3-diol, 2,2,4,4-tetra-n-pentylcyclobutane-1,3-diol, 2,2,4,4-tetra-n-hexylcyclobutane-1,3-diol, 2,2,4,4-tetra-n-heptylcyclobutane-1,3-diol, 2,2,4,4-tetra-n-octylcyclobutane-1,3-diol, 2,2-dimethyl-4,4-diethylcyclobutane-1,3-diol, 2-ethyl-2,4,4-trimethylcyclobutane-1,3-diol, 2,4-dimethyl-2,4-diethyl-cyclobutane-1,3-diol, 2,4-dimethyl-2,4-di-n-propylcyclobutane-1,3-diol, 2,4-n-dibutyl-2,4-diethylcyclobutane-1,3-diol, 2,4-dimethyl-2,4-diisobutylcyclobutane-1,3-diol, and 2,4-diethyl-2,4-diisoamylcyclobutane-1,3-diol. Desirably, the diol is selected from 2,2,4,4-tetraalkylcyclobutane-1,3-diol, 2,2-dimethyl-1,3-propanediol (neopentyl glycol), 1,2 cyclohexanedimethanol, 1,3-cyclohexanedimethanol, 1,4 cyclohexanedimethanol, 2,2,4-trimethyl-1,3-pentanediol, hydroxypivalyl hydroxypivalate, 2-methyl-1,3-propanediol, 2-butyl-2-ethyl-1,3-propanediol, 2-ethyl-2-isobutyl-1,3-propanediol, 1,3-butanediol, 1,4-butanediol, 1,5-pentanediol, 1,6-hexanediol, 2,2,4,4-tetramethyl-1,6-hexanediol, 1,10-decanediol, 1,4-benzenedimethanol, ethylene glycol, propylene glycol, diethylene glycol, dipropylene glycol, triethylene glycol, tetraethylene glycol, and polyethylene glycol, and polyols such as 1,1,1-trimethylol propane, 1,1,1-trimethylolethane, glycerin, pentaerythritol, erythritol, threitol, dipentaerythritol, sorbitol, and combinations thereof.

The suitable diacid components are hexahydrophthalic anhydride (HHPA), tetrahydrophthalic anhydride, tetrachlorophthalic anhydride, 5-norbornene-2,3-dicarboxylic anhydride, 5-norbornene-2,3-dicarboxylic acid, 2,3-norbornanedicarboxylic acid, 2,3-norbornanedicarboxylic acid anhydride, adipic acid, maleic anhydride, maleic acid, fumaric acid, itaconic anhydride, succinic acid, succinic anhydride, 1,3 cyclohexanedicarboxylic acid, 1,4 cyclohexanedicarboxylic acid, isophthalic acid, terephthalic acid, glutaric acid, itaconic acid, citraconic anhydride, citraconic acid, dodecanedioic acid, sebacic acid, azelaic acid, 1,3 cyclohexanedicarboxylic acid, 1,4 cyclohexanedicarboxylic acid, isophthalic acid, terephthalic acid and mixtures thereof.

Representative polyester polyols include Tetrashield™ IC3020, and Tetrashield™ IC3000 available commercially from Eastman Chemical Company, and Desmophen™ 7116 and 631 from Covestro AG.

Acrylic polyols also have utility in this invention. Representative acrylic polyols include Setalux™ 1903, 1905, 1906, 1910 available commercially from Allnex, and Joncryl™ 500, 906, 910 available commercially from BASF.

The present invention includes and expressly contemplates any and all combinations of embodiments, features, characteristics, parameters, and/or ranges disclosed herein. That is, the invention may be defined by any combination of embodiments, features, characteristics, parameters, and/or ranges mentioned herein.

This invention can be further illustrated by the following examples of preferred embodiments thereof, although it will be understood that these examples are included merely for purposes of illustration and are not intended to limit the scope of the invention unless otherwise specifically indicated.

### EXAMPLES

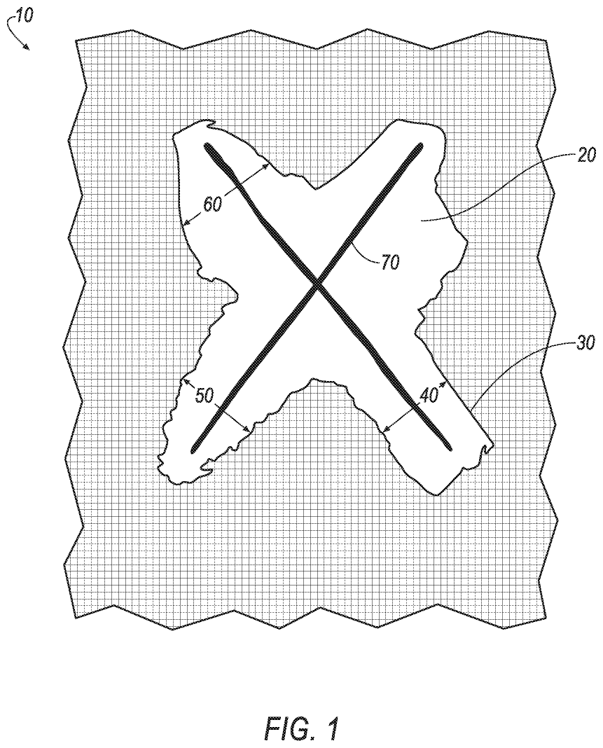

Testing for paint examples: Corrosion testing was done by ASTM B117 with an “X” scribe in the painted panel according to standard ASTM protocols. Panels were rated after a specified amount of time by immersing in hot tap water for 30 minutes, then scraping with a steel spatula to remove all loose paint. A scribed and cleaned painted test panel is represented by 10 in FIG. 1. Painted metal is represented by the cross hatching. The initial “X” scribe on the painted test panel is represented by 70. Bare metal is represented at 20 and the paint-bare metal boundary is represented at 30. Bare metal arm width was measured by averaging three widths on a corroded panel (40, 50 and 60 in FIG. 1). The rater selected the three most consistent arms on the scribed panel for measurements.

The three measurements were recorded and averaged for each corrosion panel. Panels were run in duplicate, for each corrosion time, so reported data is an average of 6 measurements (in mm).

For many applications, like agricultural or construction equipment, corrosion is needed on multiple substrates. Four common metal substrates are hot dip galvanized metal (HDG), shot blasted steel, (SSPC rated SP10), cold rolled steel, and iron phosphate pretreated steel. These substrates were purchased from ACT Test Panel Technologies as:

TABLE 1
Substrates for corrosion testing

| Abbreviation | Description | ACT part # |
|---|---|---|
| HDG | Hot dipped galvanized | 53170 |
| CRS | Cold Rolled Steel | 10161 |
| SBS | Shot blasted steel 1 mil profile | 56093 |
| B1000 | Iron Phosphate Treated Cold | 10430 |
| | Rolled Steel | |

The shot blasted panels were received in a dry, foil protected bag and when the packets were opened, they were stored in a desiccator. The CRS and HDG panels were coated with a protective oil to minimize surface corrosion. This oil was removed prior to use by wiping first with acetone, then with xylene until the panels were cleaned.

The paints were applied to the panels by roller to 7-9 mil wet film thickness. After curing for a minimum of 24 hrs. at room temperature, the panels were coated on the panel's back and edges with PPG Multiprime™ primer (available commercially from PPG Industries, Inc.) to eliminate corrosion from the uncoated surfaces. The panels were then allowed to cure for a minimum of 7 days prior to corrosion testing. Corrosion testing was done using ASTM B117 salt fog corrosion.

### Example Set 1: Baseline Performance

Protective coatings were made and tested on SBS, CRS, B1000 and HDG to test the corrosion resistance of Eastman Tetrashield™ IC3020 compared to Setalux™ 1903.

The following materials are listed in the tables:

Aromatic 100 is light aromatic naphtha solvent available from ExxonMobil.

IC3020™ is a polyester resin available commercially from Eastman Chemical Company.

Zoldine MS-Plus™ is a moisture scavenger available commercially from Angus Chemical.

Disperbyk 164™ is a wetting and dispersing additive available from BYK USA Inc.

BYK™-A501 is a release additive available from BYK USA Inc.

BYK™-306 is a silicone containing additive for coating systems available from BYK USA Inc.

BYK™-392 is a solution of a polyacrylate available from BYK USA Inc.

Crayvallac™ Ultra is a rheology modifier available from Arkema Inc.

Ti-Pure™ R960 is a titanium oxide pigment available from the Chemours Company.

Microtalc IT Extra is a talc available from Mondo Minerals B.V. Vulcan™ XC72R GP 3921 is a carbon black available from Cabot Corporation.

MICRODOL™ EXTRA is a calcium magnesium carbonate powder available from Omya Hustadmarmor AS, Knarrevik

MAK is methyl amyl ketone available from Eastman Chemical Company.

Tinuvin™ 292 is a bis (1, 2, 2, 6, 6-pentamethyl-4-piperidyl) sebacate and methyl 1, 2, 2, 6, 6-pentamethyl-4-piperidyl sebacate light stabilizer for coatings available from BASF.

Tinuvin™ 400 is a 2-hydroxy-phenyl-s-triazone derivative UV absorber available from BASF>

DBTDL 1% in A100 is dibutyl tin dilaurate available from Air Products which was diluted with Aromatic 100.

Setulux 1903 is an acrylic polyol available commercially from Allnex.

TABLE 2
Millbase for Example Set 1

| Millbase 1 | | |
|---|---|---|
| Item | Millbase | pph |
| 1 | IC3020¹ | 21.59 |
| 2 | Zoldine MS-Plus | 1.29 |
| 3 | Disperbyk 164 | 1.00 |
| 4 | BYK-A501 | 0.97 |
| 5 | Crayvallac Ultra | 1.37 |
| 6 | Ti-pure R960 | 24.97 |
| 7 | Microtalc IT Extra | 6.44 |
| 8 | Vulcan XC72R GP 3921 | 0.32 |
| 9 | MICRODOL EXTRA | 29.11 |
| 10 | MAK | 12.93 |

TABLE 3
Millbase 2 for Example Set 1

| Millbase 2 | | |
|---|---|---|
| Item | Component | pph |
| 1 | Setalux 1903 | 21.59 |
| 2 | Zoldine + | 1.29 |
| 3 | Disperbyk 164 | 1.00 |
| 4 | BYK-A501 | 0.97 |
| 5 | Crayvallac Ultra | 1.37 |
| 6 | Ti-pure R960 | 24.97 |
| 7 | Microtalc IT Extra | 6.44 |
| 8 | Vulcan XC72R GP 3921 | 0.32 |
| 9 | MICRODOL EXTRA | 29.11 |
| 10 | MAK | 12.93 |

Each millbase was made as follows:

The millbase was adjusted in scale to the total amount needed for testing. An appropriately sized steel vessel for a high-speed disperser was selected. A cowles blade whose diameter that was between 0.5 to 0.66 the diameter of the steel vessel was attached to the high-speed disperser. Items 1 to 4 from Tables 2 and 3 were added and the disperser was set to 100 rpm with the blade level just below the surface of the liquid.

Once the liquid was uniform, items 5 through 9 from Tables 2 and 3 were added sequentially and slowly.

The speed of the disperser was increased in stages to 2500-3000 RPM during the additions. Some of item 10 from Tables 2 and 3 was added as needed to maintain good dispersion viscosity.

The millbase was held at this rpm until a temperature of >47 C was obtained for at least 10 min, and a Hegman reading of >6.5 was measured. Remaining material of item 10 was added slowly as the speed of the disperser was lowered to about 100-200 rpm

The millbase was then stirred for an additional 10 minutes to ensure uniformity. The millbase was then transferred to a container and sealed until needed for formulations.

TABLE 4
Formulations for Example Set 1

| | | Example 1 | Example 1 |
|---|---|---|---|
| | | Paint 1 | Paint 2 |
| Item | Millbase | pph | pph |
| Millbase-1 | IC3020 | 54.80 | 0.00 |
| Millbase-32 | Nuplex 1903 | 0.00 | 55.09 |
| | Resins | | |
| 1 | IC3020 | 15.52 | 0.00 |
| 2 | Nuplex 1903 | 0.00 | 15.30 |
| | Let-down | | |
| 3 | BYK-306 | 0.03 | 0.03 |
| 4 | BYK 392 | 0.50 | 0.55 |
| 5 | Tinuvin 292 | 0.26 | 0.29 |
| 6 | Tinuvin 400 | 0.31 | 0.34 |
| 7 | DBTDL 1% in A100 | 1.31 | 1.43 |
| | Part B | | |
| 8 | DESMODUR | 14.74 | 14.58 |
| | N3390 BA/SN | | |
| Thin | MAK | 12.52 | 12.39 |
| solvent | | | |

Formulation Blending:

The size of the formula was scaled to that needed for testing. The millbase was added to an appropriately sized container. Under low shear agitation (3 blade propeller stirring) items 1 through 7 from Table 4, were added sequentially with a minimum of 2 minutes between item additions. The paint with no part “b” was then sealed in a jar. Just prior to paint application, item 8 from Table 4 and the thin solvent were added to the paint and mixed thoroughly.

Paints were applied using a heavy nap 4″ wide polyamide roller. They were applied to each substrate to a wet film build of 7-9 mils as measured by a notch comb wet film build gauge available from PPG. Paint was applied to the following substrates:

TABLE 5
Panel Matrix Example Set 1

| Substrate | Size | # panels/paint |
|---|---|---|
| HDG | 4″ × 6″ | 6 |
| CRS | 4″ × 6″ | 6 |
| SBS | 4″ × 6″ | 6 |
| B1000 | 3″ × 6″ | 6 |

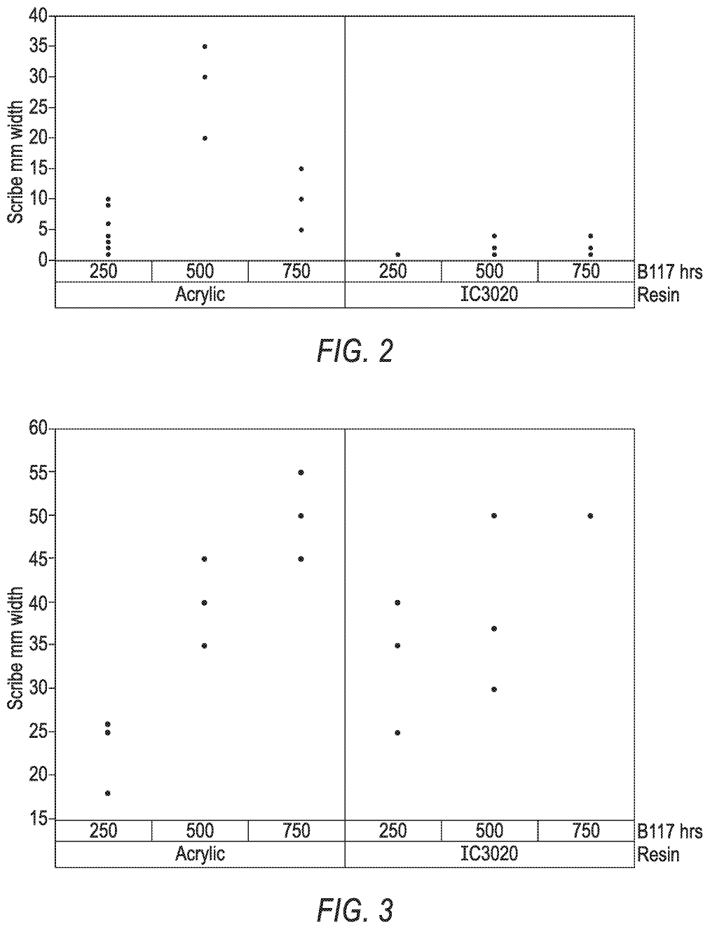

Paints were cured and panels prepared for ASTM B117 corrosion as specified in the testing section above. Two panels from each paint were removed from ASTM B117 corrosion at 250, 500, and 750 hrs. The scribe corrosion is shown graphically in FIGS. 2-5.

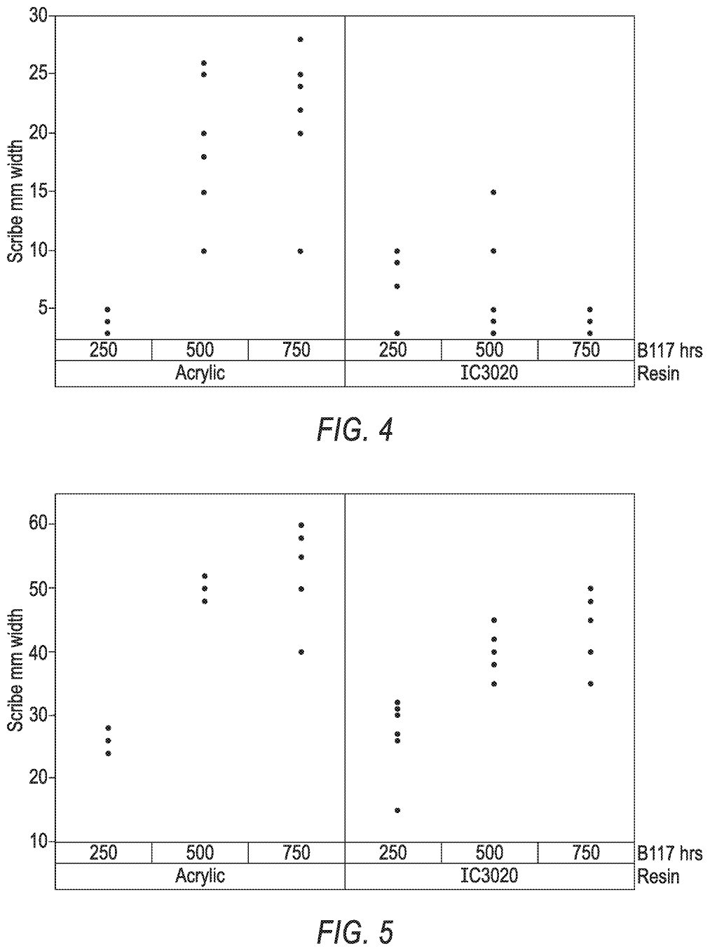

On shot blasted steel (SBS) corrosion performance, as measured by scribe width is very good for IC3020 coatings containing TMCD based polyester compared to the Nuplex 1903 coatings (“Acrylic in the charts”). Performance is also good on clean HDG (See FIG. 2 and FIG. 4). However, on smooth CRS and B1000, there is severe delamination along the scribe for both the acrylic and the TMCD polyester, see FIG. 3 and FIG. 5.

### Experimental Set 2: Effect of Grafting PTSI

TABLE 6
Paint and Resin Descriptions for Example Set 2

| | | | | Level PTSI |
|---|---|---|---|---|
| | | | | on total |
| Paint | | Additive/ | | paint solids |
| code | Resin | resin | Description | wt. % |
| PT3 | IC3020 | IC3020 | IC30200 control | 0 |
| PT2 | A | BMESI | benzyl methyl ester | |
| | | | sulfonyl isocyanate | |
| PT1 | B | IC3020 | PTSI IC3020 | 3.5 |
| PT4 | C | IC3020 | 1/2 PTSI on graft | 1.75 |
| | | | (PTSI I3020 0.5) | |
| PT5 | D | IC3020 | 1/4 PTSI on graft | 0.875 |
| | | | (PTSI I3020 0.25 | |
| PT6 | E | IC3020 | 3.5 PTSI post add | 3.5 |
| PT7 | F | IC3020 | .875 PTSI post add | 0.875 |

TABLE 7
Example Set 2 graft resins composition.

| | | | benzyl methyl | | wt. % graft |
|---|---|---|---|---|---|
| | Grams | Grams | ester sulfonyl | gram n- | on resin |
| Resin | IC3020 | PTSI | isocyanate | BA | solids |
| A | 200.00 | 0.00 | 38.76 | 12.92 | 20.53% |
| B | 500.00 | 79.21 | 0.00 | 26.40 | 17.44% |
| C | 500.00 | 39.60 | 0.00 | 13.20 | 9.55% |
| D | 500.00 | 19.80 | 0.00 | 6.60 | 5.02% |

Resins (Materials A-D) were made by placing the IC3020 solution into a jar with ample space for the PTSI or benzyl methyl ester sulfonyl isocyanate and additional n-butyl acetate. The jar was then equipped with a 3-blade propeller stirrer and blanketed with a steady flow of dry nitrogen. The isocyanate (either PTSI or the benzyl methyl ester sulfonyl isocyanate) was then added dropwise over 20 minutes. A 10-20-degree Celsius exotherm was observed for these reactions. Additional n-butyl acetate was added to bring the resulting resins to 75% NV. The propeller stirrer was removed and the jars were capped with a nitrogen blanket and allowed to cool overnight. IR spectroscopy was run on the solution to ensure that no remaining R—NCO was observable.

The final resin properties are shown below. These properties were calculated based on IC3020 OH #150 on resin solids and initially at 75% NV in n-butyl acetate, and the NCO equivalent weight of the different mono-isocyanates used for grafting.

TABLE 8
Experimental Set 2 graft resin properties

| | | | | Final | |
|---|---|---|---|---|---|
| | | EQ | Final EQ | OHEQ | Final % |
| Resin | EQ OH | NCO | OH | WT | NV |
| A | 0.401 | 0.161 | 0.240 | 785.7 | 75.00 |
| B | 1.003 | 0.402 | 0.601 | 756.3 | 75.00 |
| C | 1.003 | 0.201 | 0.802 | 517.2 | 75.00 |
| D | 1.003 | 0.101 | 0.902 | 437.6 | 75.00 |

### Abbreviations

EQ OH—The equivalent of OH groups on the resin from the original resin charge.
EQ NCO—The equivalent of NCO groups on the isocyanate from the original isocyanate charge.
Final EQ OH—The final equivalents of hydroxyl after the isocyanate/OH reaction is complete.
Final OHEQ W T—The weight (in grams) of the final resin that contains one equivalent of OH groups.
Final % NV—The final % nonvolatile resin in the solution after the reactions and additions are complete.

For the paints in this test set, the millbase is shown in Table 9. Similar procedures as used for the millbases in Example Set 1 were used to make this millbase.

TABLE 9
Millbase (MB) for Example Set 2

| | | | OH | | | | | | |
|---|---|---|---|---|---|---|---|---|---|
| Millbase 3 | | | Eq. | | % Pigment | | % on | % Pigment | % resin |
| Item | Component | pph | Wt. | % NV | on solids | Eq. | solids | solids | solids |
| 1 | IC3020 | 21.59 | 374.0 | 75.0 | 0.0 | 0.269 | 20.06 | 0.00 | 81.47 |
| 2 | Zoldine+ | 1.29 | 92.5 | 100.0 | 0.0 | 0.086 | 1.60 | 0.00 | 6.49 |
| 3 | Disperbyk 164 | 1.00 | 0.0 | 60.0 | 0.0 | 0.000 | 0.74 | 0.00 | 3.02 |
| 4 | BYK-A501 | 0.97 | 0.0 | 44.0 | 0.0 | 0.000 | 0.53 | 0.00 | 2.14 |
| 5 | Crayvallac | 1.37 | 0.0 | 100.0 | 0.0 | 0.000 | 1.70 | 0.00 | 6.89 |
| | Ultra | | | | | | | | |
| 6 | Ti-pure R960 | 24.97 | 0.0 | 100.0 | 100.0 | 0.000 | 30.93 | 41.04 | 0.00 |
| 7 | Microtalc IT | 6.44 | 0.0 | 100.0 | 100.0 | 0.000 | 7.98 | 10.59 | 0.00 |
| | Extra | | | | | | | | |
| 8 | Vulcan | 0.32 | 0.0 | 100.0 | 100.0 | 0.000 | 0.40 | 0.53 | 0.00 |
| | XC72R GP | | | | | | | | |
| | 3921 | | | | | | | | |
| 9 | MICRODOL | 29.11 | 0.0 | 100.0 | 100.0 | 0.000 | 36.06 | 47.84 | 0.00 |
| | EXTRA | | | | | | | | |
| 10 | MAK | 12.93 | 0.0 | 0.0 | 0.0 | 0.000 | 0.00 | 0.00 | 0.00 |

The paints for this series were made and applied for corrosion testing as per paints in Example set 1. The formulas are shown in Table 10.

TABLE 10
Paints for Example Set 2
All units are parts by weight

| Item | Component | PT1 | PT2 | PT3 | PT4 | PT5 | PT6 | PT7 |
|---|---|---|---|---|---|---|---|---|
| 1 | Millbase 3 | 54.50 | 54.50 | 54.48 | 54.49 | 54.49 | 52.93 | 54.10 |
| | Resins | | | | | | | |
| 2 | IC3020 | 0.00 | 0.00 | 15.47 | 0.00 | 0.00 | 15.03 | 15.36 |
| 3 | A | 0.00 | 19.08 | 0.00 | 0.00 | 0.00 | 0.00 | 0.00 |
| 4 | B | 18.92 | 0.00 | 0.00 | 0.00 | 0.00 | 0.00 | 0.00 |
| 5 | C | 0.00 | 0.00 | 0.00 | 17.19 | 0.00 | 0.00 | 0.00 |
| 6 | D | 0.00 | 0.00 | 0.00 | 0.00 | 16.33 | 0.00 | 0.00 |
| | Let-down | | | | | | | |
| 7 | BYK-306 | 0.04 | 0.04 | 0.04 | 0.04 | 0.04 | 0.04 | 0.04 |
| 8 | BYK 392 | 0.71 | 0.71 | 0.71 | 0.71 | 0.71 | 0.69 | 0.70 |
| 9 | Tinuvin 292 | 0.37 | 0.37 | 0.37 | 0.37 | 0.37 | 0.36 | 0.37 |
| 10 | Tinuvin 400 | 0.44 | 0.44 | 0.44 | 0.44 | 0.44 | 0.43 | 0.44 |
| 11 | DBTDL 1% | 1.84 | 1.84 | 1.84 | 1.84 | 1.84 | 1.79 | 1.83 |
| | in A100 | | | | | | | |
| | Part B | | | | | | | |
| 12 | DESMODUR | 11.78 | 11.65 | 14.67 | 13.24 | 13.96 | 11.66 | 13.91 |
| | N3390 BA/SN | | | | | | | |
| 13 | PTSI | 0.00 | 0.00 | 0.00 | 0.00 | 0.00 | 2.38 | 0.61 |
| 14 | MAK | 11.39 | 11.36 | 11.96 | 11.68 | 11.82 | 14.69 | 12.65 |

TABLE 11
Panel matrix for Example Set 2

| Substrate | Size | # panels/paint |
|---|---|---|
| CRS | 4″ × 6″ | 4 |
| B1000 | 3″ × 6″ | 4 |

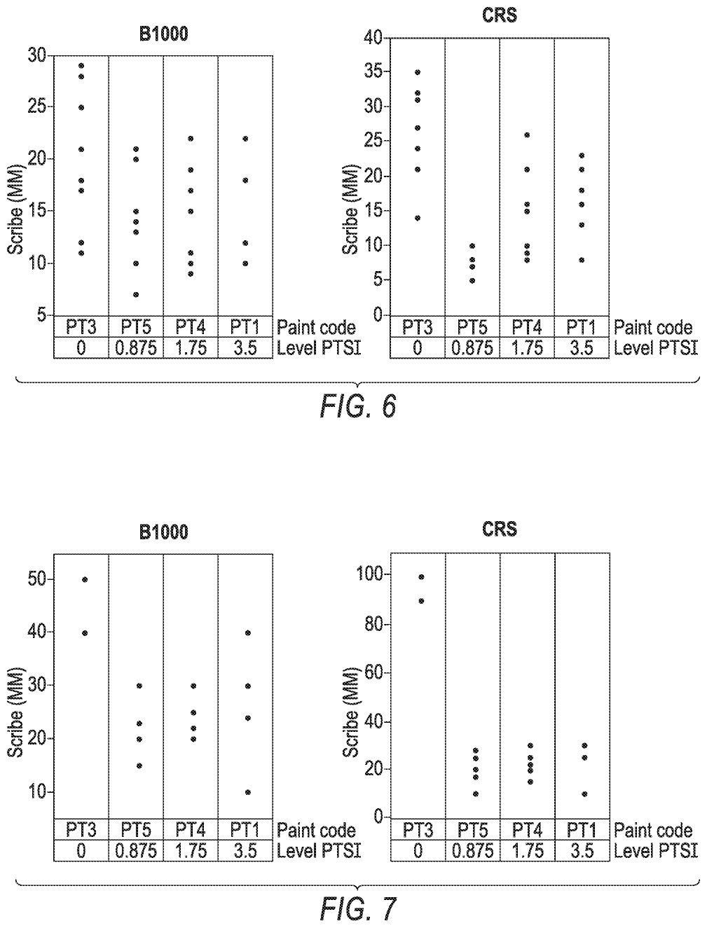

Paints were cured and prepared for ASTM B117 corrosion as specified in the testing section above. Two panels from each paint and substrate were removed from ASTM B117 corrosion at 250, and 750 hrs. The scribe corrosion is plotted FIGS. 6 and 7.

As depicted in FIGS. 6 and 7, corrosion improves when PTSI is grafted onto the TMCE polyol resin. The improved performance difference is more pronounced after 750 hours of testing as shown by FIG. 7.

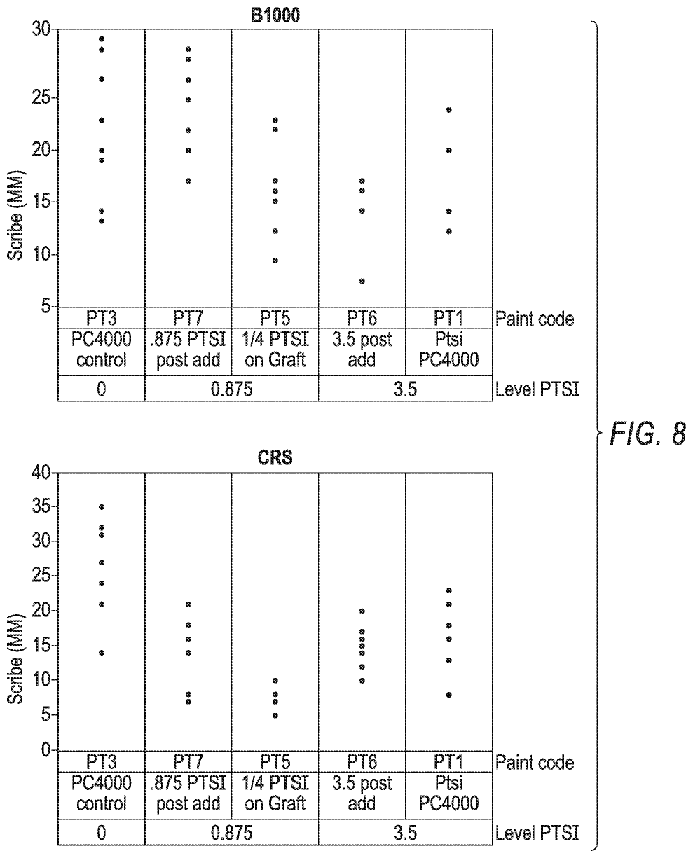

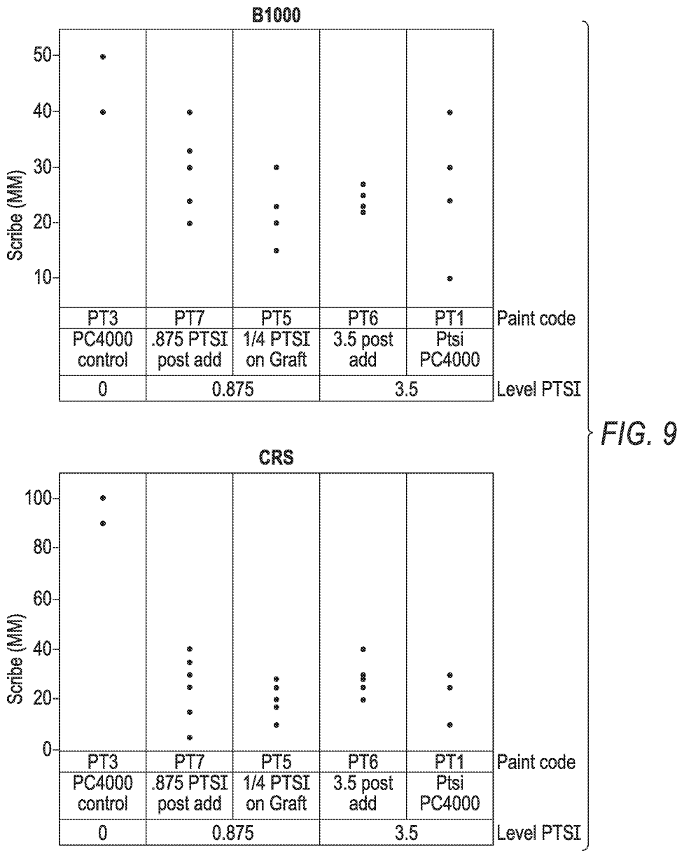

There are three ways that PTSI can be added to a two-component isocyanate paint. One is by grafting it onto a resin (Graft), the other is blending it in with the crosslinker and adding it when the A and B components of the paint are blended and applied to the substrate (Post Add). Another is to use a combination of Graft and Post Add additions, by adding a) a resin having grafted PTSI and b) an ungrafted PTSI to the paint. All three methods will improve the corrosion resistance performance of a coating, but surprisingly grafting the PTSI onto the resin is the most efficient means, requiring less PTSI and showing better and/or more consistent corrosion results. This is true for both CRS and iron phosphated steel (see FIG. 8 and FIG. 9).

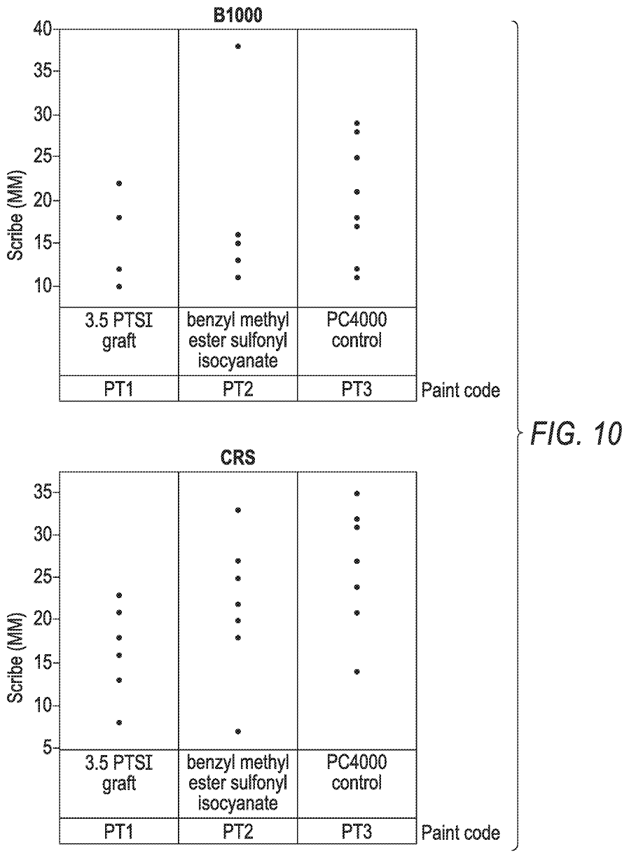

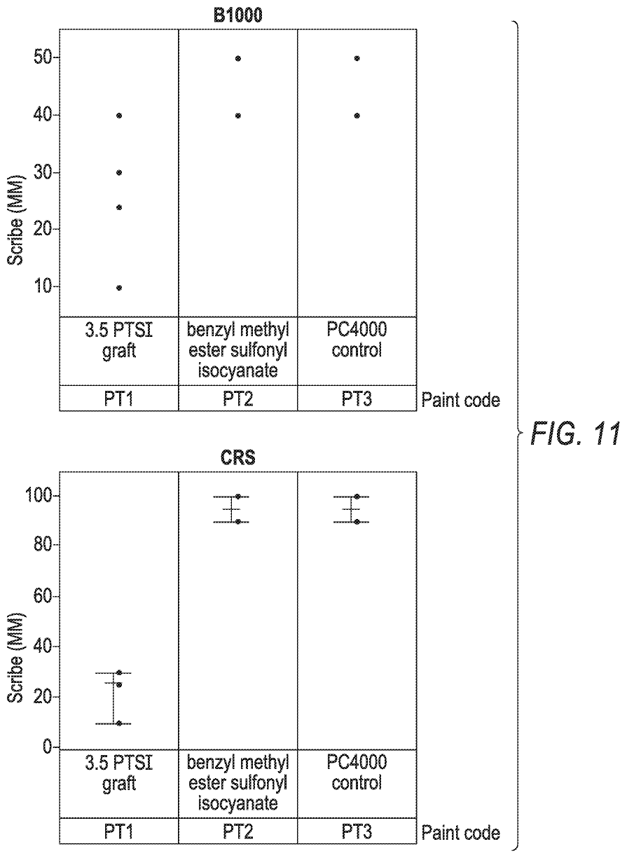

To determine if there are other similar isocyanates that would work as effectively as PTIS, we compared the performance of benzyl methyl ester sulfonyl isocyanate to PTSI. The results for corrosion performance, shown in FIGS. 10 and 11, clearly indicate that PTSI is significantly better than the other isocyanate.

The invention has been described in detail with reference to the embodiments disclosed herein, but it will be understood that variations and modifications can be effected within the spirit and scope of the invention. It will further be understood that any of the ranges, values, or characteristics given for any single component of the present disclosure can be used interchangeably with any ranges, values or characteristics given for any of the other components of the disclosure, where compatible, to form an embodiment having defined values for each of the components, as given herein throughout. Further, ranges provided for a genus or a category, can also be applied to species within the genus or members of the category, unless otherwise noted.

We claim:

1. A resin composition for use in a coating, said resin-composition including a polyol component having not more than 25 percent sulfonyl urethane groups.

2. The resin composition of claim 1 wherein said polyol component is a polymer.

3. The resin composition of claim 2 wherein said polyol component is a polyester polyol.

4. The resin composition of claim 2 wherein said polyol component is an acrylic polyol.

5. The resin composition of claim 1 wherein said coating is a direct to metal coating.

6. The resin composition of claim 2 wherein said polymer comprises the residue of a) a polyester polyol or an acrylic polyol and b) an aromatic sulfonyl isocyanate.

7. The resin composition of claim 6 wherein said aromatic sulfonyl isocyanate is selected from the group consisting of paratoluenesulfonyl isocyanate, benzyl methyl ester sulfonyl isocyanate, and benzyl sulfonyl isocyanate.

8. A composition for use in a coating comprising the residues of:
a. a polyol having an initial OH Fn greater than 2.66; and
b. an aromatic sulfonyl isocyanate wherein said composition has not more than 25 percent sulfonyl urethane groups and not less than 75 percent remaining hydroxyl groups.

9. The composition of claim 8 where said polyol is a polyester polyol.

10. The composition of claim 8 where said polyol is an acrylic polyol.

11. A coating composition comprising:
a. at least one polyester resin comprising residues of a polyester polyol and an aromatic sulfonyl isocyanate wherein said resin has not more than 25 percent sulfonyl urethane groups and not less than 75 percent hydroxyl groups;
b. a solvent other than water; and
c. a crosslinker comprising a polymeric isocyanate, wherein said isocyanate is selected from the group consisting of an aliphatic poly isocyanate; an aromatic poly isocyanate, an aliphatic isocyanate; an aromatic isocyanates and mixtures thereof.

12. The coating composition of claim 11 further comprising d) an ungrafted aromatic sulfonyl isocyanate.

13. A coating composition comprising:
a. at least one acrylic resin comprising residues of an acrylic polyol and an aromatic sulfonyl isocyanate wherein said resin has not more than 25 percent sulfonyl urethane groups and not less than 75 percent remaining hydroxyl groups;
b. a solvent ether than water; and
c. a crosslinker comprising a polymeric isocyanate, wherein said isocyanate is selected from the group consisting of an aliphatic poly isocyanate; an aromatic poly isocyanate, an aliphatic isocyanate; an aromatic isocyanates and mixtures thereof.

14. The coating composition of claim 13 further comprising d) an ungrafted aromatic sulfonyl isocyanate.

15. A method of improving the corrosion resistance of a metal substrate comprising:
a. forming a polyester resin, said resin comprising the residues of at least two polyol components and at least one acid component wherein at least one of said polyol components contains free hydroxyl functionality;
b. reacting an aromatic sulfonyl isocyanate with said resin to form a grafted polyester resin wherein said grafted polyester resin has not more than 25 percent sulfonyl urethane groups and not less than 75 percent hydroxyl groups;
c. combining said grafted polyester with a coating composition; and
d. coating said metal substrate with said combined grafted polyester and coating composition.

16. The method of claim 15 further comprising the step of combining an ungrafted aromatic sulfonyl isocyanate with said grafted polyester and said coating composition, prior to coating said metal substrate.

17. A method of improving the corrosion resistance of a metal substrate comprising:
a. forming an acrylic polyol resin, said resin comprising the residues of the radical copolymerization of an acrylic monomer with an ester wherein at least one of said acrylic polyol components contains free hydroxyl functionality;
b. reacting an aromatic sulfonyl isocyanate with said acrylic polyol resin to form a grafted acrylic polyol resin wherein said grafted acrylic polyol resin has not more than 25 percent sulfonyl urethane groups and not less than 75 percent hydroxyl groups;
c. combining said grafted acrylic polyol resin with a coating composition; and
d. coating said metal substrate with said combined grafted acrylic polyol resin and coating composition.

18. The method of claim 17 further comprising the step of combining an ungrafted aromatic sulfonyl isocyanate with said grafted acrylic polyol resin and said coating composition, prior to coating said metal substrate.
